(19) United States
(12) Patent Application Publication
(10) Pub. No.: US 2001/0024461 A1
(43) Pub. Date: Sep. 27, 2001

(54) Semiconductor laser with surge protection and optical pickup using the same

(75) Inventor: Naotaro Nakata, Kyoto-shi (JP)

Correspondence Address: ARENT FOX KINTNER PLOTKIN & KAHN, PLLC, Suite 600, 1050 Connecticut Avenue, N.W, Washington, DC, 20036-5339, US

(73) Assignee: ROHM CO., LTD.

(21) Appl. No.: 09/804,187

(22) Filed: Mar. 13, 2001

(30) Foreign Application Priority Data
Mar. 13, 2000 (JP) 2000-069244

(51) Int. Cl. H01S 3/00

(52) U.S. Cl. 372/38.09; 372/38.07

(57) ABSTRACT

A plurality of leads (11 to 13) are secured to a stem so as to extend up and down in a state of being electrically isolated respectively, and thereby a stem (1) is formed, a laser chip (2) is provided by connecting the anode and cathode thereof with two leads on one side thereof, at least one of the anode and cathode thereof is electrically connected with one lead (11) through a wire (8) and a circumference of a laser chip (2) is covered with a cap (4) And, a chip condenser (3) is bonded between two leads (11, 12), to which an anode and a cathode of a laser chip are connected, in the other side (an exposed side not covered with a cap) of the stem not through a wire but directly with an electro-conductive agent. Therefore, a semiconductor laser with a surge protection, having a structure in which burdensome works are not required in fabricating steps and a protective condenser may surely absorb a surge when it enters, and an optical pickup using it can be obtained.

### FIELD OF THE INVENTION

The present invention relates to a semiconductor laser and an optical pickup using a semiconductor laser, which are particularly suitable for being used as a light source for pickups of CD (compact disk), DVD (digital versatile disk), LBP (laser beam printer), DVD-ROM and so on. More specifically, the present invention relates to a semiconductor laser with a surge protection, in which the capacity of withstanding breakdown by a surge is enhanced by connecting a condenser parallel to a laser diode.

### BACKGROUND OF THE INVENTION

Conventionally, when a semiconductor laser is attached in a pickup, a laminated ceramic condenser 33 is connected between an anode wiring 31 and a cathode wiring (common) 32 of interconnections provided on a surface of a flexible circuit board 30 as shown in FIG. 5(a), and it is taken to prevent a semiconductor laser from being broken down due to the surge such as static electricity when mounting a semiconductor laser, not shown, or handling it after mounting. Further, in FIG. 5(a), reference numerals 21, 22, 23 are through holes which are formed in such a way that a semiconductor laser (hereinafter, refer to also as LD) may be mounted for instance by inserting leads of a can seal type semiconductor laser, and respective holes are for an anode lead, a common lead and a photodetector lead of a monitor.

In a conventional pickup, a protective condenser 33 is attached to a flexible circuit board 30 (since a pickup takes a sliding motions, such a flexible circuit board is necessary) as shown in FIG. 5(a), and also a soldering terminal 34 for a short is provided on end side of a flexible circuit board as shown in FIG. 5(b) and the soldering terminal 34 is soldered to short both wiring 31, 32 in advance. The soldering terminal 34 for the short is provided to eliminate a charge of a protective condenser attached previously when soldering LD to a flexible circuit board 30 and to prevent LD from being broken down due to the contact of a flexible circuit board 30 with a charged substrate in soldering a photodetector and terminals of a lens actuator. Solder 35 of the soldering terminal 34 for a short is drawn and short is released after a flexible circuit board 30 is soldered to a pickup and connector terminals 36 of a flexible circuit board 30 is plugged into a connector.

A driving circuit of a pickup is turned on, a regenerative signal of a disk is measured, and an adjustment of a position of a photodiode for a monitor is finished to complete a pickup. After fabricating the pickup, a soldering terminal 34 for a short of a flexible circuit board 30 is soldered again and shorted, and then a pickup is fed to a fabricating line of a mechanical deck. In a fabricating line of a mechanical deck, a pickup is attached to a mechanical deck, and after a flexible circuit board 30 is plugged into a connector, solder of the soldering terminal 34 for a short is drawn again and a test of regenerating signals is carried out. As shown in FIG. 5(b), there is a case of shorting by clamping connector terminals 36 with a short pin 37 in place of the soldering terminal for a short described above.

On the other hand, as shown in FIG. 6 as well as for instance in Japanese Unexamined Patent Publication No. Hei 3-283482, there are shown a semiconductor laser in which a chip condenser 26 is located near a LD chip 25 and the chip condenser is connected in parallel to LD chip 25 by bonding a wire such as a gold wire 27, or a chip condenser is connected in parallel to a LD chip and an inductance element connected to a LD chip in series, not shown. By the way, a reference numeral 28 is a heatsink.

In a structure in which a condenser is attached previously to a conventional flexible circuit board, there is a distance of at least about L=2 to 6 mm between a location of a flexible circuit board 30 on which a protective condenser 33 is attached and a location on which an LD is attached. The inductance of wiring of the flexible circuit board is considered as a flat wire inductor, and in a general flexible circuit board wiring with 200 μm in width and 10 μm in thickness, the inductance increases as the wiring length becomes longer as shown in FIG. 7. Therefore, though it is possible to protect LD sufficiently when a surge enters into the position of the direction opposite to LD from location provided with a protective condenser 33, when a surge enters into the position being closer to LD than the location provided with a protective condenser 33, or in attaching LD, lead pins of LD contacts directly with a substrate charged with static electricity or an operator charged contacts with lead pins of LD, there is a problem in which a surge flows into LD chip being closer to the contacted location to break down LD.

Furthermore, even though a protect condenser is attached to a flexible circuit board, it is impossible to protect a laser chip completely when an anode wiring and a cathode wiring of LD are not shorted on end side of the wirings, and there is a problem which makes fabricating works burdensome.

And, as shown in FIG. 6, when a semiconductor laser is configured so as to incorporate a protective condenser connected by a wire bonding, an inductance is produced by a wire. That is, results of measuring an inductance, varying length of leads of condensers with leads, are shown for a case A of 2 MHz, a case B of 10 MHz and a case C of 100 MHz, respectively, in FIG. 8, and it indicates that the inductance L increases as the length of the lead increases. It is found that when a withstand voltage test of the method of EIAJ 200 pF, 0 Ω, which is described thereinafter, is performed, a time delay of 30 ns is produced in a current flowing to the condenser in existence of a inductance of 5 to 10 nH. Therefore, when a surge enters, it flows into an LD chip side precedently and a surge may not be absorbed sufficiently by a protective condenser having a larger inductance and there is a problem of breaking down an LD chip.

### SUMMARY OF THE INVENTION

It is an object of the present invention to provide a semiconductor laser with a surge protection, solving such problems and having a structure in which burdensome works are not required in fabricating steps and a protective condenser may surely absorb a surge when it enters.

It is an another object of the present invention to provide an optical pickup and an optical disk player using the semiconductor laser.

A semiconductor laser with a surge protection in accordance with the present invention comprises; a stem to which a plurality of leads are secured so as to extend up and down in a state of being electrically isolated respectively, a laser chip, an anode and a cathode of which are electrically connected to two leads of the plurality of leads in one side of the stem, at least one of the anode and the cathode is connected through a wire, a cap covering circumference of the laser chip, and a chip condenser bonded between the two leads, to which an anode and a cathode of said laser chip are connected, in the other side of the stem not through a wire but directly with an electro-conductive agent.

Here, a description “being connected directly with an electro-conductive agent” means that being connected with an electro-conductive material being less prone to cause a inductance such as solder and an electro-conductive adhesion.

By using this structure, since a protective chip condenser is connected to leads of a semiconductor laser not through a wire but directly, its inductance becomes as small as at most 2 nH and therefore it is possible to absorb the charge by the condenser without time delay even though a surge such as static electricity is applied directly to leads of a semiconductor laser. Moreover, since a laser chip is connected through leads of a stem and a wire such as a gold wire, an inductance is formed in a region between the external terminals of leads and the laser chip, and therefore the charge due to a surge is less prone to advance toward the laser chip side (a time delay is occurred) and prone to be absorb by the protective chip condenser. That is, since the protective condenser is most close to the semiconductor laser among the position to be possibly applied with a surge and also is connected to the location farthest from the laser chip, a surge to be possibly applied to leads is absorbed all by the protective condenser and the laser chip is protected even though an inductance element is not specially connected.

By connecting an inductance element in series to at least one of connections between the anode and the cathode of the laser chip and two leads, the inductance differentials between a route to the protective condenser and a route to the laser chip side increases further and therefore this provides further protection of the laser chip.

An another embodiment of a semiconductor laser in accordance with the present invention comprises; at least two leads, a laser chip, an anode and a cathode of which are electrically connected to one-end sides of the two leads and a cover covering a circumference of the laser chip and exposing the other-end sides of the at least two leads so as to output light from the laser chip, and an inductance element is connected in series between at least one of the anode and the cathode and the lead to which the one of the anode and the cathode is connected, and a chip condenser is connected between the two leads, not through a wire but directly with an electro-conductive agent.

Here, the cover described above includes caps such as a can seal put onto a stem and a package such as that coating a part of the laser chip with resin. Further, a term of an inductance element means an element producing a stronger inductance per unit length than a usual wire.

Even though using such structure, since a protective chip condenser is not connected through a wire and therefore it is connected with an inductance as very small as at most 2 nH, it is possible to keep a sufficient inductance differential between the protective condenser and the laser chip side by only connecting a small inductor having a slight inductance to the laser chip side, and the laser chip may be protected from a surge.

It is possible to absorb almost the charge due to a surge by a condenser and to protect the laser chip when the chip condenser is formed in such a way that an inductance is 2 nH (nanohenry) or less between the two leads to which the condenser is connected.

An optical pickup in accordance with the present invention comprises; a semiconductor laser, a beam splitter separating the light exiting from the semiconductor laser from the light reflected and returned, an objective lens focussing a beam from the semiconductor laser onto an optical disk and a photodetector detecting the reflected light from the optical disk separated by the beam splitter, and the semiconductor laser consists of the semiconductor laser as set forth in claim 1 or 3.

An optical disk player in accordance with the present invention is constituted by providing further a disk rotator and a sliding mechanism to move the optical pickup in addition to the foregoing optical pickup.

### BRIEF DESCRIPTION OF THE DRAWINGS

FIGS. 1(a) and 1(b) are illustrative views showing a structure of one embodiment of a semiconductor laser in accordance with the present invention.

FIG. 2 is a view showing characteristics of withstanding voltage in varying a protective condenser in a semiconductor laser of FIGS. 1.

FIG. 3 is an illustrative view showing another embodiment of a semiconductor laser in accordance with the present invention.

FIG. 4 is an illustrative view of an example of constituting a pickeup by using a semiconductor laser shown FIGS. 1.

FIGS. 5(a) and 5(b) are illustrative views showing an example of mounting a semiconductor laser onto a flexible circuit board used for a conventional CD and the like.

FIG. 6 is an illustrative view of a structure of a conventional semiconductor laser provided with a protective condenser.

FIG. 7 is a view showing a change of an inductance by a wire length of a flexible circuit board.

FIG. 8 is a view showing a change of an inductance by a lead length of a condenser with a lead.

### DETAILED DESCRIPTION

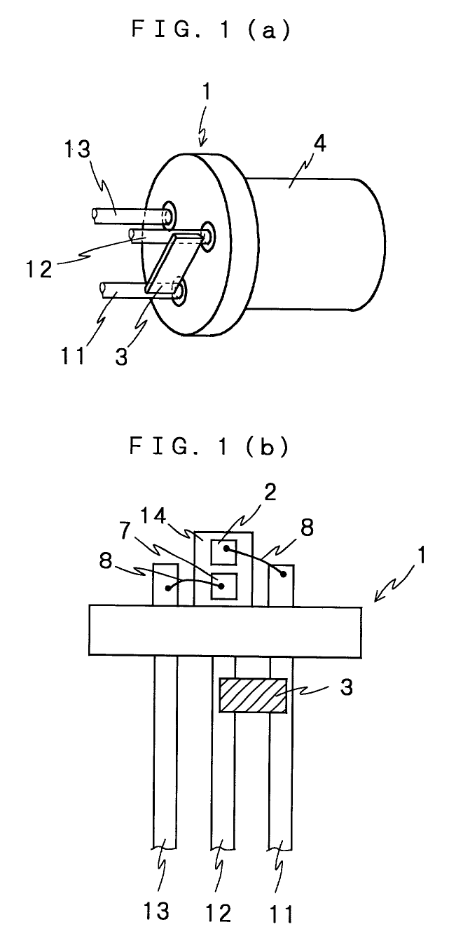

Referring now to the drawings, there is illustrated a semiconductor laser in accordance with the present invention. In a semiconductor laser of the present invention, as illustrative views of one embodiment thereof are shown as a perspective view and a side view of a state in which a cap is removed in FIGS. 1(a) and 1(b), a plurality of leads 11 to 13 are secured to a stem so as to extend up and down in a state of being electrically isolated respectively, and thereby a stem 1 is formed. A laser chip 2 is provided on one side of the stem 1, an anode and a cathode of the laser chip is electrically connected to two leads 11, 12, and at least one of them is connected through a wire 8, and a circumference of the laser chip 2 is covered with a cap 4. And, a chip condenser 3 is bonded between two leads 11, 12, to which an anode and a cathode of the laser chip 2 are connected, in the other side (an exposed side not covered with a cap 4) of the stem 1 not through a wire but directly with an electro-conductive agent.

A laser chip 2 consists of a double heterostructure being for instance the semiconductor of AlGaAs based compound similar to a conventional one and is mounted on a base 14 which acts a roll of a heatsink and is electrically connected to a common lead 12 through the silicon sub-mount, not shown. Further, a reference numeral 7 denotes a photodetector for monitoring in FIG. 1(b). In this embodiment, one anode electrode of the laser chip 2 is electrically connected to the first lead 11 through a wire 8 such as a gold wire and a cathode electrode is electrically connected to a lead 12 through a base 14. Further, one electrode of a photodetector 7 for monitoring is electrically connected to a lead 13 with a wire 8.

As shown in FIG. 1(a), a chip-type laminated ceramic condenser 3 is connected between leads 11, 12 on opposite side to a side applied with a cap not through a lead but directly by soldering and the like. The laminated ceramic condenser has preferably a capacity of 0.5 μF or more as described thereinafter and a condenser not with a lead but in a chip form is preferably bonded to a lead directly. The reason why a chip condenser 3 is externally attached, not being provided within a cap 4, is that there is not the possibility of an surge applied to an inside of a cap 4 directly and a surge is applied through leads 11, 12 and therefore this is a position most close to a laser chip 2, where a surge is possibly applied, and a position as far as possible from a laser chip 2 toward a surge side.

By such an arrangement, a surge to be possibly applied necessarily immediately flows into the protective chip condenser 3 and a time delay is produced to flow into the laser chip 2. Therefore, a surge does not flow into the laser chip 2 and the laser chip 2 is protected.

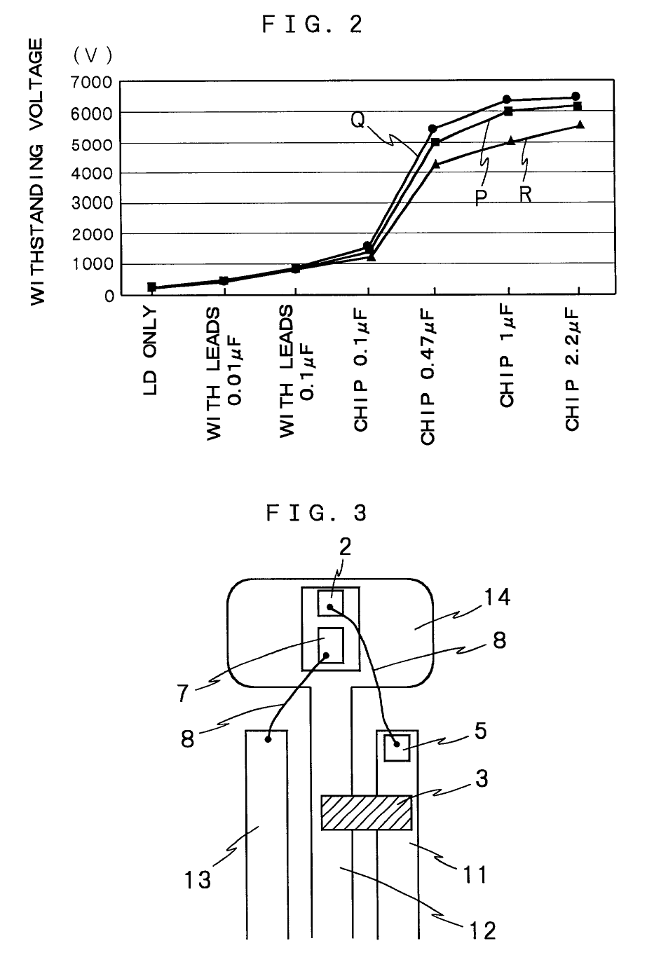

With this structure, varying a capacity of the condenser 3 and kinds of a condenser with a lead and a chip-type condenser, a withstand voltage test was performed and it was examined what voltage the condensers withstand. As for a kind of a condenser, there were tested six kinds of condensers, i.e., with leads (5 mm of lead length) and 0.01 μF, with leads and 0.1 μF, a chip-type and 0.1 μF, a chip-type and 0.47 μF, a chip-type and 1 μF and a chip-type and 2.2 μF, and a device (LD only) without the protective condenser. A withstand voltage test is performed according to the method of EIAJ 200 pF, 0 Ω (a method in which a condenser of 200 pF is charged at a voltage to be examined and a breakdown of a laser chip is judged by the value of a surge voltage by which an operating current is increased by 10 mA compared with the value before an application of a surge when the charged condenser is connected between leads of LD having no load resistance (0 Ω)). Results of a test are shown as a mean value P, a maximum value Q and a minimum value R in FIG. 2.

As is apparent from FIG. 2, in a device without a condenser and devices provided with condensers with leads, though it was not possible to enhance the withstanding voltage sufficiently, the withstanding voltage was improved significantly in devices attached directly with chip-type condensers and it was improved up to 5000 V and more on average when a capacity of a chip condenser is 0.47 μF or more. That is, it is understood that a resistance to a surge of the semiconductor laser is significantly enhanced by attaching a chip-type condenser of 0.47 μF or more directly to outside of the leads of the semiconductor laser. Furthermore, though a conventional device without the condenser was broken down at 250 V, the withstanding voltage of the device attached directly with a chip condenser of 2.2 μF was enhanced up to 6500 V at the maximum. As is apparent from FIG. 2, it is preferred that the capacity of the protective condenser is large but when its capacity becomes large, a configuration of the device also becomes large, and therefore the capacity is selected in consideration of the relationship between the required withstanding voltage and the allowable space. From FIG. 2, it is preferred that the condenser has a capacity of 0.5 μF or more but when the condenser has a capacity of 0.4 μF or more, it is improved in the withstanding voltage much more than the conventional structure.

In accordance with the present invention, the protective chip condenser is attached to the exposed location of the leads of the semiconductor laser, which a surge possibly enters and is most close to the main body and farthest from the laser chip by a means of attaching directly not using a wire so as not to produce an inductance. Therefore, even though a surge is applied externally to the leads of the semiconductor laser directly or through another wire, since the laser chip is connected far from the position to which the protective chip condenser is attached via a lead and a wire, there is an inductance thereof of 5 to 10 nH and a time delay of 30 ns or more is produced in the foregoing test method, and therefore a surge is absorbed by the condenser and it does not happen that the laser chip is broke down. Therefore, the laser chip becomes free of a breakdown due to a surge charged in a flexible circuit board and the like even when a semiconductor laser is attached to a flexible circuit board or carried during fabricating process and the handling becomes very easy and also reliability is improved significantly.

The embodiment described above utilizes an inductance due to leads and wires in a section from the chip condenser to the laser chip, and it is possible to ensure a sufficient inductance to protect the laser chip in a usual semiconductor laser by attaching the protective chip condenser directly, but an inductance element may also be connected in series between a laser chip and a lead for more safety. As an inductance element, it is sufficient only to produce a slight inductance of the order of 5 to 100 nH and components of miniature size such as a chip inductor may be used.

FIG. 3 is an illustrative plan view showing a semiconductor laser of a plane mounting type being an another embodiment. This example has a structure which is provided with a covering part, not shown, protecting a laser chip except a portion through which the light from the laser chip is transmitted with resin and a chip condenser 3 is provided in a portion covered with the covering part. In this example, by interposing a inductance element 5 at the position at which a wire 8 is connected between the laser chip 2 and a lead 11, an inductance on a side of a laser chip 2 is sufficiently attainable since the chip condenser 3 is attached directly to leads 11, 12 as described above and therefore it is sufficiently to protect the laser chip 2. Also in this case, it is sufficient only to produce a inductance of the order of at most 5 to 100 nH as an inductance element 5 and a chip inductor, for instance, may be used. By the way, like reference characters between FIG. 1 and FIG. 3 designate corresponding parts and FIG. 3 are not described further.

As a result of using a condenser of miniature size of 0.1 μF as a chip condenser 3 and an inductance element 5 of 100 nH, there was achieved the surge-resistant characteristic of 6500 V similar to that of the foregoing example in which a condenser of 2.2 μF was used. And, by using this structure, since the protective condenser is incorporated in a covering part, it does not hinder a person from handling and this becomes the semiconductor laser being very easy to handle and improved in reliability. Further, though an example shown in FIG. 3 shows the semiconductor laser of a plane mounting type and covered with resin at the covering part, this structure is, not limited to this example, similarly applicable to that using a stem as described above.

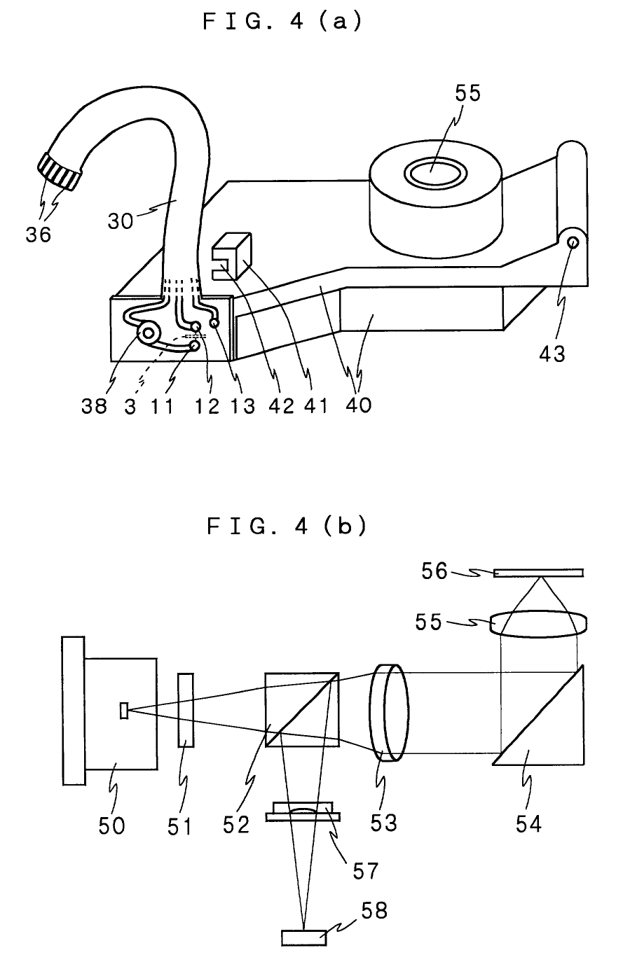

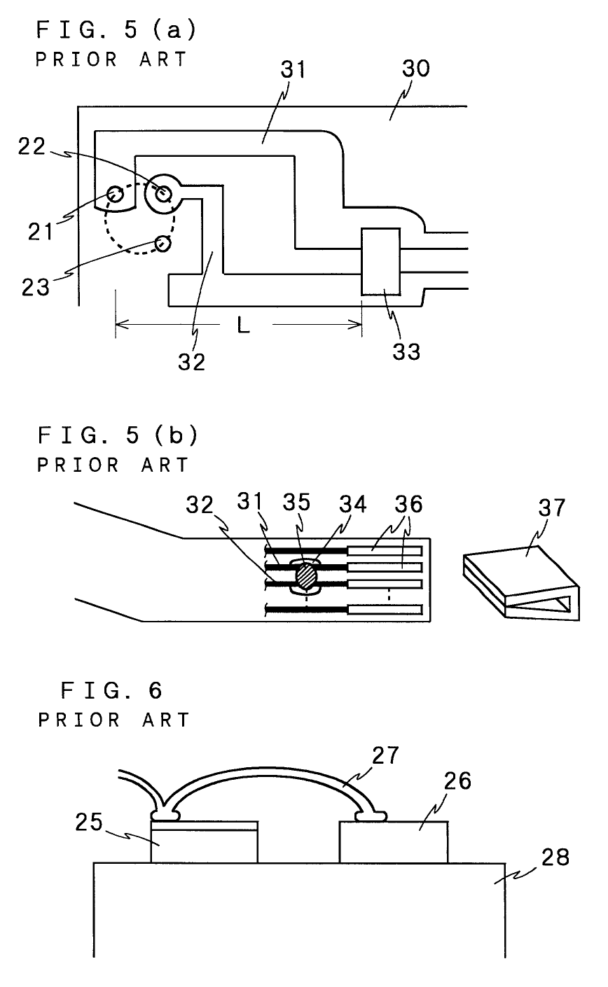

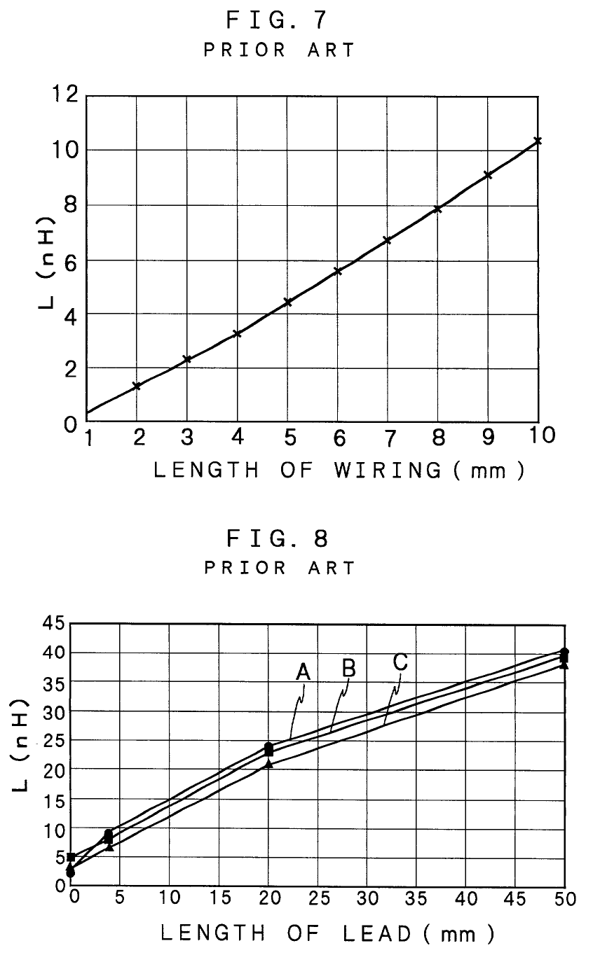

An illustrative view of constitution of an example of a pickup using a semiconductor laser shown FIGS. 1(a) and 1(b) is shown in FIG. 4(a). That is, as shown in FIG. 4(a), leads 11, 12, 13 of a semiconductor laser shown FIGS. 1(a) are inserted into through holes of a flexible circuit board 30 attached to one wall face of a body and soldered. The semiconductor laser is mounted in a body 40 and a chip condenser 3 is connected to the root of the leads 11, 12 (shown as a symbol of a condenser with a broken line in FIG. 4(a)). In addition, a reference numeral 38 indicates a volume for regulating an output of the semiconductor laser and another required components, not shown, are mounted as well, and this system is configured so as to supply a power supply and signals by providing the wirings and forming connector terminals 36 at the other end of the flexible circuit board 30.

In a body 40, as an illustrative view of a constitution of a three beams method, for instance, is shown in FIG. 4(b), a semiconductor laser 50 is located laterally, the light from the semiconductor laser 50 is split into three beam by a diffraction grating 51, the split beam transmitted through a beam splitter 52 separating the light exiting from the semiconductor laser from reflected light is made to be a parallel beam by a collimator lens and turned by 90 degrees of angles (in the direction of Z axis) by a prism mirror (a reflection mirror) 54 and focused by an objective lens 55 onto a surface of an optical disk 56 of DVD or CD. And, this system is configured in such a way that reflected light from the optical disk 56 is transmitted through a beam splitter 52 and a concave lens 57 and detected by a photodetector 58. Further, there is an optical pickup using a definite system objective lens in which a collimator lens and an objective lens are integrated into one lens. This objective lens is kept in an optimum position to reading out on a disk by an actuator having a focus servo mechanism and a tracking servo mechanism.

A pickup is retained so as to be slid by a hardware 41 attached to the body 40 or guide grooves 42, 43 provided directly on the body 40, and a optical disk player is configured by being provided with a placing stage and a rotating mechanism of an optical disk, not shown and a sliding mechanism to move an optical pickup, and this system has a structure which allows a optical pickup to slide through flexibility of a flexible circuit board and signals to be detected while operating a tracking servo mechanism and a focus servo mechanism. A breakdown of a semiconductor laser due to static electricity and the like is resolved also in a steps of fabricating such an optical pickup and an optical disk player and the handling becomes easy and also reliability is improved significantly.

Though, in the example shown in FIG. 4(a), a structure of the semiconductor laser is that shown in FIG. 1(a), the semiconductor laser having a structure shown in FIG. 3 also may compose an optical pickup and an optical disk player.

As described above, in accordance with the present invention, since it is possible to reduce an inductance to the protective condenser by attaching the chip condenser directly to the leads, and further it is possible to form a difference of the inductance for the protective condenser and the laser chip by bonding a wire to the laser chip side, so it is possible to achieve the semiconductor laser having very large resistance for a surge through a very simple constitution. Further, since the semiconductor laser itself is attached with the protective condenser, it is not required to attach previously the protective condenser to a flexible circuit board and the handling becomes very easy in attaching a semiconductor laser to a flexible circuit board and also in carrying in fabricating process, a significant simplification of the works is achieved and reliability is also improved significantly.

Further, in accordance with the present invention, it will be not required to exercise excessive care to avoid a breakdown of the semiconductor laser in the steps of fabricating the optical pickup and the optical disk player, and it is possible to reduce the manufacturing cost and the reliability is also improved significantly.

Although preferred examples have been described in some detail it is to be understood that certain changes can be made by those skilled in the art without departing from the spirit and scope of the invention as defined by the appended claims.

What is claimed is:

1. A semiconductor laser comprising:
a stem to which a plurality of leads are secured so as to extend up and down in a state of being electrically isolated, respectively,
a laser chip, an anode and a cathode of which are electrically connected to two leads of said plurality of leads in one side of said stem, at least one of said anode and said cathode is connected through a wire,
a cap covering circumference of said laser chip, and
a chip condenser bonded between said two leads, to which an anode and a cathode of said laser chip are connected, on the other side of said stem not through a wire but directly with an electro-conductive agent.

2. The semiconductor laser as set forth in claim 1, wherein an inductance element is connected in series to at least one of connections between an anode and a cathode of said laser chip and said two leads to which said anode and said cathode, respectively, are electrically connected.

3. A semiconductor laser comprising:
at least two leads,
a laser chip, an anode and a cathode of which are electrically connected to one-end sides of said two leads,
a cover covering a circumference of said laser chip and exposing the other-end sides of said at least two leads so as to output light from said laser chip,
an inductance element is connected in series between at least one of said anode and said cathode and a lead to which said one of said anode and said cathode is connected, and
a chip condenser connected between said two leads, not through a wire but directly with an electro-conductive agent.

4. The semiconductor laser as set forth in claim 1 or 3, wherein said chip condenser is formed in such a way that an inductance is 2 nH or less between said two leads.

5. The semiconductor laser as set forth in claim 1 or 3, wherein a capacity of said chip condenser is 0.4 μF or more.

6. An optical pickup comprising:
a semiconductor laser,
a beam splitter separating the light exiting from said semiconductor laser from the light reflected and returned,
an objective lens focussing a beam from said semiconductor laser onto an optical disk, and
a photodetector detecting the reflected light from said optical disk separated by said beam splitter,
wherein said semiconductor laser consists of the semiconductor laser as set forth in claim 1 or 3.

7. An optical disk player being constituted by providing further a disk rotator and a sliding mechanism to move the optical pickup in addition to said optical pickup as set forth in claim 6.
